(19) United States
(12) Patent Application Publication
(10) Pub. No.: US 2012/0015199 A1
(43) Pub. Date: Jan. 19, 2012

(54) Method of Sealing Concrete and Sealed Product

(75) Inventor: Paul Turner, Clinton Twp., MI (US)

(73) Assignee: Nanotech Concrete Solutions LLC, Henderson, NV (US)

(21) Appl. No.: 12/837,219

(22) Filed: Jul. 15, 2010

(51) Int. Cl. B32B 9/04; B05D 3/00

(52) U.S. Cl. 428/447; 427/372.2

(57) ABSTRACT

A method of reducing deterioration or corrosion of a concrete substrate, including adding or applying a first sealer to a concrete substrate prior to or after pouring thereof, or applying the first sealer after at least partial curing of the concrete substrate. After at least partial curing of the concrete substrate, a penetrative silane second sealer is applied to at least one surface of the substrate, with the second sealer differing from the first sealer. The sealed product comprises an at least partially cured concrete slab having nanopores substantially filled by a first sealer, and a coating of a penetrative silane second sealer on at least one surface of the concrete substrate, with the second sealer differing from the first sealer.

### BACKGROUND OF THE INVENTION

The present invention relates to a method of coating or sealing concrete, and in particular to reducing deterioration or corrosion of a concrete substrate. The present invention also relates to the sealed concrete product itself.

Concrete as a substrate is a preferred material for construction of, by way of example only, floors, pavements, basins, trenches, and containment structures, especially in industrial applications. Concrete is critical to a country's infrastructure, including roads, bridges, water and waste water storage and the like. Concrete has a low cost, is easy to apply, and has a relatively long service life. However, concrete has a microstructure that allows the permeation of water and corrosive chemicals, which cause premature failing of the concrete surface. Even more critical is the fact that concrete allows infiltration of corrosives to the metal reinforcement, or rebar, thereof, thus causing complete failure of the structure.

It is therefore an object of the present invention to provide an improved method for sealing a concrete substrate, as well as to the sealed concrete substrate itself.

### BRIEF DESCRIPTION OF THE DRAWINGS

This object, and other objects and advantages of the present application, will appear more clearly from the following specification in conjunction with the accompanying schematic drawings, in which:

FIG. 1 shows an untreated concrete slab, along with the nanopore structure thereof;

FIG. 2 shows a concrete slab that has been treated with a densifer; and

FIG. 3 shows the structure of FIG. 2 after being treated with a silane sealer pursuant to the teaching Of the present application.

### SUMMARY OF THE INVENTION

The method of the present application for reducing deterioration or corrosion of a concrete substrate comprises pouring a concrete substrate; adding or applying a first sealer to the concrete substrate prior to or after the pouring step, or applying the first sealer after at least partial curing of the concrete substrate; thereafter at least partially curing the concrete substrate; and applying a silane second sealer, in particular a penetrative silane sealer, to at least one surface of the at least partially cured concrete substrate to thereby reduce deterioration or corrosion of the concrete substrate, for example due to chemical attack, wherein the second sealer differs from the first sealer.

The method can also comprise the steps of pouring a concrete substrate; adding or applying a first sealer to the concrete substrate prior to or after the pouring step, or applying the first sealer after partial curing of the concrete substrate; thereafter at least partially curing the concrete substrate; and applying a penetrative silane second sealer to at least one surface of the at least partially cured concrete substrate, wherein the second sealer differs from the first sealer.

The sealed concrete can comprise an at least partially cured concrete substrate having nanopores that are substantially filled by a first sealer; and a coating of a penetrative silane second sealer on at least one surface of the concrete substrate, wherein the second sealer differs from the first sealer. Depending upon the condition of the concrete, the type of first sealer, etc., the first sealer could, for example, fill the nanopores to a depth of about ⅛ inch or more.

Further specific features of the present application will be described in detail subsequently.

### DESCRIPTION OF SPECIFIC EMBODIMENTS

Referring now to the drawings in detail, the present application relates to a method of sealing concrete, and to the sealed product produced by such a method. More specifically, the present application provides a method of reducing deterioration or corrosion of a concrete substrate.

Concrete, which is essentially a combination of cement (binder) and aggregate, is mixed with water, either on site, or, for example, in a special truck, and is poured. The resulting concrete slab is, by nature, porous, containing air voids or nanopores. Such pores interfere with surface uniformity, and make the slab more susceptible to staining from spilled liquids as well as to deterioration or corrosion from water infiltration and caustic or acidic chemicals. It should be noted that some of the cement can be replaced by other materials known to those of skill in the art, such as by milled glass or fly ash.

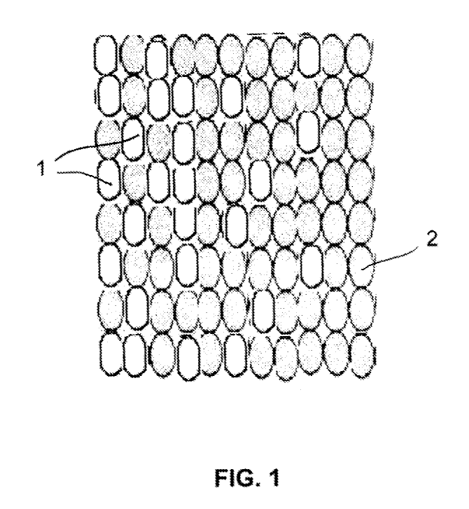

FIG. 1 schematically shows air voids or nanopores 1 in a fresh (i.e. still green) or existing (i.e. old or cured) concrete slab 2. The porous nature of the concrete slab 2 due to the presence of the nanopores 1 is readily apparent.

To fill at least a large portion of the voids and nanopores, and to thus increase surface density, a first sealer, known as a densifier, is added or applied to the concrete substrate prior to or after the concrete is poured. Such a densifier is a penetrative sealer, and contains as an active substituent or carrying agent alkali or alkaline earth metal silicate, such as lithium, sodium, magnesium or potassium silicate, with lithium silicate being preferred. Examples of commercial densifiers include Pentra-Sil® (NL) from Convergent ConcreteTechnologies Inc (Lithium Silicate), Starseal PS CT101 from Vexcon Chemicals Inc (Potassium Silicate), and CHEMTECH ONE from Chemtec International. The densifier or penetrative first sealer can be applied to either a green or existing concrete slab, for example by means of a sprayer, broom, roller, mop or squeegee, or by any other convenient application means. Alternatively, with some products it would also be possible to add the densifier as an admixture to the concrete prior to pouring of the slab, for example at the plant. If the concrete slab is an existing slab, it should first be cleaned, for example chemically or by grinding.

The penetrative first sealer or densifier works by forming an insoluble bond with the free lime in the concrete. In particular, the chemical reaction that takes place forms extremely strong tri-calcium silicate compounds that bind together micro particles (lime and fine aggregate) into a non-expansive gel, which rapidly cures into inorganic cement that is stronger and more durable than was the cement by itself. A very low viscosity densifier such as lithium silicate penetrates extremely well into the nanopores or capillary channels of the concrete, thus providing a more consistent and uniform cure. The small molecular size of the densifier allows deep penetration into the concrete of, by way of example only, up to ¼ inch. The depth of penetration is, however, not uniform since the slab itself is often not uniform, for example due to variances in compaction, soundness, binder size, aggregate grading, and the like. The depth of penetration is determined by the porosity of the concrete. Lithium silicate-based densifiers are preferred since they result in an insoluble bond within the nanopores of the concrete. Although magnesium fluorosilicates, sodium silicates and potassium silicates could also be used, they are not as preferable since they form soluble bonds.

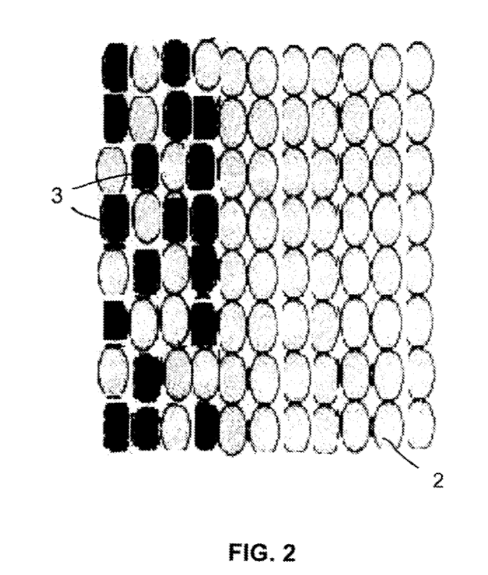

FIG. 2 schematically illustrates how the tri-calcium silicate 3 that resulted from the chemical reaction of the lithium silicate densifier in the concrete has filled a large portion of the nanopores that existed in the concrete substrate as illustrated in FIG. 1.

After the concrete slab 2, to which densifier has been added or applied (FIG. 2), has cured for a sufficient length of time, for example a minimum of 24 hours, a second sealer is applied to the surface of the at least partially cured concrete slab or substrate. This second sealer differs from the first sealer or densifier, and is a silane, in particular a penetrative silane. The second sealer bonds to the surface of the concrete slab and to the densifier added or applied thereto, and in so doing also penetrates to fill at least most of the existing voids not filled by the densifier, in particular by bonding to the densifier-coated pore surfaces near and below the surface of the concrete slab. The second sealer forms a protective coating or barrier layer both on and below the surface to protect the concrete slab by improving resistance to deterioration or corrosion caused by weather, chemicals, mechanical damage such as caused by vehicles, and other environmental degradation.

The penetrative silane second sealer is, in particular, a composition comprised of at least one alkoxy siloxane or alkoxysilane. Other penetrative silanes, also known as penetrating silanes, could also be used, such as, by way of example only, fluoros-silanes.

Commercial examples of the second sealer include HabraCoat® and various XurGard formulations, all produced by Xurex Inc. of Albuquerque, N. Mex. The second sealer can contain an alcohol, such as methanol, to enhance penetration. Other alcohols, such as, by way of example only, ethanol or isopropyl alcohol, could also be used.

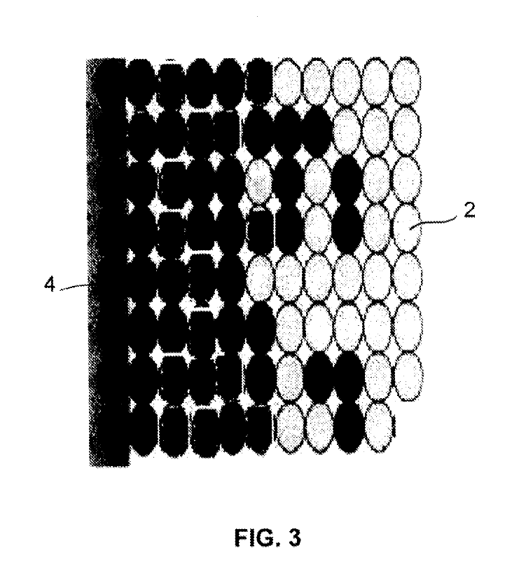

FIG. 3 illustrates the state of the concrete slab 2 to which densifier has already been added or applied as in FIG. 2, after the additional application of the second sealer 4. FIG. 3 schematically illustrates how the second sealer 4 not only provides a coating on the outer surface of the concrete slab 2, but has also penetrated to largely fill still existing nanopores or capillary channels not completely filled by the densifier.

The present invention has been described in conjunction with a concrete slab. In this regard, it should be noted that the concrete slab or substrate need not necessarily be in a horizontal orientation, but could also be disposed at an angle or could even be disposed vertically. In such a case, it is to be understood that it may be necessary to apply two or more coats of the second sealer to the concrete slab in order to ensure that a sufficient amount of the second sealer is available for penetration and the formation of the protective coating.

To impart other desired properties to the floor, additives could be admixed with one or more of the concrete, the densifier, and the second sealer to the extent that they are compatible therewith, such as colorizers, epoxy, UV protectants, and the like.

To maximize effectiveness of the present method, it is presently believed that the temperature of the concrete substrate should be 55° F.-75° F. at the time of application. In addition, the temperature of the substrate should not be within 5° F. of the dew point, and the relative humidity should not be greater than 90%.

### Example 1

430 square feet of old concrete were prepared by cleaning with a broom and/or by power washing.

A five-gallon pail of Pentra-Sil® (NL) Concrete Densifier Nano Lithium surface treatment was spread over the 430 square feet by brushing and rolling it on. The concrete surface was wet with densifier for a minimum of 20 minutes and was allowed to dry.

After 24 to 30 hours of densifier cure, one gallon of XurGard, mixed in accordance with the manufacturer's recommendations, was applied to the 430 square feet by using a short nap mohair roller cover.

After a 30 minute wait period, a second gallon of XurGard was applied.

The air temperature was approximately 75° F. during applications.

### Example 2

An 89-square foot existing concrete floor was ground using heavy-duty grinding/polishing machines.

The concrete densifier Pentra-Sil® (NL) Nano Lithium was applied to the polished floor by pouring and brushing in.

After the densifier was dry, further polishing steps were undertaken.

After 40 hours of densifier cure, 340 ml of HabraCoat® was applied with a roller.

After 30 minutes of cure the HabraCoat® was buffed to drive it into the polished floor and to polish the top coat.

The present invention is, of course, in no way restricted to the specific disclosure of the specification and drawings, but also encompasses any modifications within the scope of the appended claims.

What I claim is:

1. A method of reducing deterioration or corrosion of a concrete substrate, comprising:
pouring a concrete substrate;
adding or applying a first sealer to said concrete substrate prior to or after said pouring step, or applying said first sealer after at least partial curing of said concrete substrate;
thereafter at least partially curing said concrete substrate; and
applying a penetrative silane second sealer to at least one surface of the at least partially cured concrete substrate to thereby reduce deterioration or corrosion of said concrete substrate, wherein said second sealer differs from said first sealer.

2. A method according to claim 1, wherein said first sealer is a densifier selected from the group consisting of lithium silicate, sodium silicate, potassium silicate, and a magnesium-based silicate.

3. A method according to claim 2, wherein said densifier is added to a concrete mixture during manufacture of said mixture.

4. A method according to claim 2, wherein said densifier is applied to said concrete substrate after said pouring step.

5. A method according to claim 4, wherein said densifier is applied to said concrete substrate after said substrate has cured at least partially.

6. A method according to claim 1, wherein said penetrative second sealer is comprised of at least one alkoxy siloxane or alkoxysilane.

7. A method according to claim 6, wherein said second sealer further contains an alcohol selected from the group consisting of methanol, ethanol and isopropyl alcohol.

8. A method, comprising:
pouring a concrete substrate;
adding or applying a first sealer to said concrete substrate prior to or after said pouring step, or applying said first sealer after partial curing of said concrete substrate;
thereafter at least partially curing said concrete substrate; and
applying a penetrative silane second sealer to at least one surface of the at least partially cured concrete substrate to protect the substrate surface against chemical attack, wherein said second sealer differs from said first sealer.

9. A method according to claim 8, wherein said first sealer is a densifier selected from the group consisting of lithium silicate, sodium silicate, potassium silicate and a magnesium-based silicate.

10. A method according to claim 9, wherein said densifier is added to a concrete mixture during manufacture of said mixture.

11. A method according to claim 9, wherein said densifier is applied to said concrete substrate after said pouring step.

12. A method according to claim 11, wherein said densifier is applied to said concrete substrate after said substrate has cured at least partially.

13. A method according to claim 8, wherein said penetrative second sealer is comprised of at least one alkoxy siloxane or alkoxysilane.

14. A method according to claim 13, wherein said second sealer further contains an alcohol selected from the group consisting of methanol, ethanol and isopropyl alcohol.

15. An apparatus, comprising:
an at least partially cured concrete substrate having nanopores that are substantially filled to a depth of approximately 1/8 inch by a first sealer; and
a coating of a penetrative silane second sealer on at least one surface of said concrete substrate to protect the substrate surface against chemical attack, wherein said second sealer differs from said first sealer.

16. An apparatus according to claim 15, wherein said first sealer is a densifier selected from the group consisting of lithium silicate, sodium silicate, potassium silicate, and a magnesium-based silicate.

17. An apparatus according to claim 15, wherein said penetrative second sealer is comprised of at least one alkoxy siloxane or alkoxysilane.

18. An apparatus according to claim 17, wherein said second sealer further contains an alcohol selected from the group consisting of methanol, ethanol and isopropyl alcohol.

19. An apparatus according to claim 15, wherein said first sealer is bonded to free lime in said concrete substrate.

20. An apparatus according to claim 15, wherein said second sealer is bonded to said first sealer.
